(19) United States
(12) Patent Application Publication
(10) Pub. No.: US 2025/0317329 A1
(43) Pub. Date: Oct. 9, 2025

(54) ELECTRONIC DEVICE AND METHOD FOR RECEIVING SIGNAL IN WIRELESS COMMUNICATION SYSTEM

(71) Applicant: Samsung Electronics Co., Ltd., Suwon-si (KR)

(72) Inventors: Ikbeom LEE, Suwon-si (KR); Kyeongyeon KIM, Suwon-si (KR); Soongyoon CHOI, Suwon-si (KR)

(21) Appl. No.: 19/244,606

(22) Filed: Jun. 20, 2025

Related U.S. Application Data
(63) Continuation of application No. PCT/KR2023/018295, filed on Nov. 14, 2023.

(30) Foreign Application Priority Data
Dec. 22, 2022 (KR) 10-2022-0181969

(51) Int. Cl. H04L 25/02

(52) U.S. Cl. CPC H04L 25/0224; H04L 25/0242

(57) ABSTRACT

An electronic device in a wireless communication system is provided. The electronic device includes at least one transceiver and at least one processor. The at least one processor is configured to obtain reception data and reception reference signals via the at least one transceiver, obtain a whitening filter for a noise and interference component based on channel estimation using the reception reference signals, obtain first whitening channel estimation information of the reception reference signals based on the whitening filter, obtain second whitening channel estimation information for the reception data based on the first whitening channel estimation information for the reception reference signals, and obtain transmission data corresponding to the reception data based on the second whitening channel estimation information of the reception data.

### CROSS-REFERENCE TO RELATED APPLICATION(S)

This application is a continuation application, claiming priority under 35 U.S.C. § 365 (c), of an International application No. PCT/KR2023/018295, filed on Nov. 14, 2023, which is based on and claims the benefit of a Korean patent application number 10-2022-0181969, filed on Dec. 22, 2022, in the Korean Intellectual Property Office, the disclosure of which is incorporated by reference herein in its entirety.

### BACKGROUND

### 1. Field

The disclosure relates to a wireless communication system. More particularly, the disclosure relates to an electronic device and a method for receiving a signal in a wireless communication system.

### 2. Description of Related Art

In order to improve transmission and reception performance of signals, a multiple-input multiple-output (MIMO) technology is used. A wireless communication system using the MIMO technology uses multiple antennas at both a transmission end and a receiving end. The channel capacity of the wireless communication system using the MIMO technology may be significantly improved compared to a single antenna technology.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the abovementioned problems and/or disadvantages and to provide at least the advantages described below. Accordingly, an aspect of the disclosure is to provide an electronic device and a method for receiving a signal in a wireless communication system.

Additional aspects will be set forth in part in the description which follows and, in part, will be apparent from the description, or may be learned by practice of the presented embodiments.

In accordance with an aspect of the disclosure, a method performed by an electronic device in a wireless communication system is provided. The method includes obtaining reception data and reception reference signals, obtaining a whitening filter for a noise and interference component based on channel estimation using the reception reference signals, obtaining first whitening channel estimation information for the reception reference signals based on the whitening filter, obtaining second whitening channel estimation information for the reception data based on the first whitening channel estimation information for the reception reference signals, and obtaining transmission data corresponding to the reception data based on the second whitening channel estimation information for the reception data.

In accordance with another aspect of the disclosure, an electronic device in a wireless communication system is provided. The electronic device includes at least one transceiver, and at least one processor. The at least one processor is configured to obtain reception data and reception reference signals via the at least one transceiver, obtain a whitening filter for a noise and interference component based on channel estimation using the reception reference signals, obtain first whitening channel estimation information for the reception reference signals based on the whitening filter, obtain second whitening channel estimation information for the reception data based on the first whitening channel estimation information for the reception reference signals, obtain transmission data corresponding to the reception data based on the second whitening channel estimation information for the reception data.

In accordance with another aspect of the disclosure, one or more non-transitory computer-readable storage media storing instructions that, when executed by at least one processor of an electronic device individually or collectively, cause an electronic device to perform operations, is provided. The operations include obtaining reception data and reception reference signals, obtaining a whitening filter for a noise and interference component based on channel estimation using the reception reference signals, obtaining first whitening channel estimation information for the reception reference signals based on the whitening filter, obtaining second whitening channel estimation information for the reception data based on the first whitening channel estimation information for the reception reference signals, and obtaining transmission data corresponding to the reception data based on the second whitening channel estimation information for the reception data.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment of the disclosure;

FIG. 2 illustrates a fronthaul interface according to an embodiment of the disclosure;

FIG. 3 illustrates an example of a resource structure in a time domain and a frequency domain according to an embodiment of the disclosure;

FIG. 4 illustrates an example of channels in a communication standard according to an embodiment of the disclosure;

FIG. 5A illustrates an example of a demodulation reference signal (DMRS) in a slot according to an embodiment of the disclosure;

FIG. 5B is a diagram for explaining a principle of whitening according to an embodiment of the disclosure;

FIG. 6 illustrates an example of a functional block of data channel estimation using whitening for a reference signal (RS) channel according to an embodiment of the disclosure;

FIG. 7 illustrates an example of a functional block of data channel estimation using whitening for a received signal according to an embodiment of the disclosure;

FIG. 8 illustrates an operation flow of an electronic device for performing data channel estimation using whitening according to an embodiment of the disclosure;

FIG. 9 illustrates an example of a performance graph of data channel estimation using whitening according to an embodiment of the disclosure;

FIG. 10 illustrates a functional configuration of a terminal according to an embodiment of the disclosure; and

FIG. 11 illustrates a functional configuration of a base station according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the disclosure described below, a hardware approach will be described as an example. However, since the various embodiments of the disclosure include technology that uses both hardware and software, the various embodiments of the disclosure do not exclude a software-based approach.

In the following description, a term referring to a signal (e.g., signal, information, symbol, message, signaling, reference signal (RS), and data), a term referring to a resource (e.g., symbol, slot, subframe, radio frame, subcarrier, resource element (RE), resource block (RB), bandwidth part (BWP), and occasion), a term for a computational state (e.g., step, operation, and procedure), a term referring to data (e.g., packet, user stream, information, bit, symbol, and codeword), a term referring to a channel, a term referring to network entities, a term referring to a component of a device, and the like are illustrated for convenience of description. Therefore, the disclosure is not limited to the terms described below, and other terms having the same technical meanings may be used.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {′C′, ‘D’, and ‘C’ and ‘D’}.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

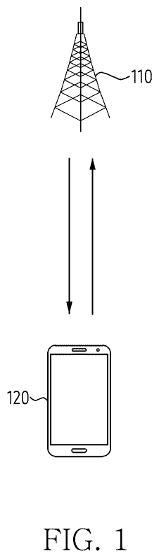

FIG. 1 illustrates an example of a wireless communication system according to an embodiment of the disclosure.

Referring to FIG. 1, FIG. 1 illustrates a base station 110 and a terminal 120 as a portion of nodes using a wireless channel in a wireless communication system. Although FIG. 1 illustrates only one base station, the wireless communication system may further include another base station identical to or similar to the base station 110.

The base station 110 is a network infrastructure for providing wireless access to the terminal 120. The base station 110 has coverage defined based on a distance at which a signal may be transmitted. In addition to a base station, the base station 110 may be referred to as an ‘access point (AP)’, an ‘eNode B (eNB)’, a ‘5th generation node’, a ‘next generation node B (gNB)’, a ‘wireless point’, a ‘transmission/reception point (TRP)’, or another term having a technical meaning equivalent thereto.

The terminal 120, which is a device used by a user, communicates with the base station 110 through the wireless channel. A link from the base station 110 to the terminal 120 is referred to as downlink (DL), and a link from the terminal 120 to the base station 110 is referred to as uplink (UL). In addition, although not illustrated in FIG. 1, the terminal 120 and another terminal may perform communication with each other through the wireless channel. In this case, a device-to-device link (D2D) between the terminal 120 and the other terminal is referred to as a sidelink, and the sidelink may be used interchangeably with a PC5 interface. In some other embodiments, the terminal 120 may be operated without user involvement. According to an embodiment, the terminal 120, which is a device that performs machine type communication (MTC), may not be carried by the user. In addition, according to an embodiment, the terminal 120 may be a narrowband (NB)-internet of things (IoT) device.

In addition to a terminal, the terminal 120 may be referred to as ‘user equipment (UE)’, ‘customer premises equipment (CPE)’, a ‘mobile station’, a ‘subscriber station’, a ‘remote terminal’, a ‘wireless terminal’, an ‘electronic device’, or another term having a technical meaning equivalent thereto.

The base station 110 may perform beamforming with the terminal 120. The base station 110 and the terminal 120 may transmit and receive a wireless signal in a relatively low frequency band (e.g., a frequency range 1 (FR 1) of NR). In addition, the base station 110 and the terminal 120 may transmit and receive a wireless signal in a relatively high frequency band (e.g., FR 2 (or FR 2-1, FR 2-2, FR 2-3), or FR 3 of NR), and a millimeter wave (mmWave) band (e.g., 28 GHz, 30 GHz, 38 GHz, or 60 GHz). To improve a channel gain, the base station 110 and the terminal 120 may perform the beamforming. Herein, the beamforming may include transmission beamforming and reception beamforming. The base station 110 and the terminal 120 may assign directivity to a transmission signal or a reception signal. To this end, the base station 110 and the terminal 120 may select serving beams through a beam search or beam management procedure. After the serving beams are selected, subsequent communication may be performed through a resource that is in a quasi-co-located (QCL) relationship with a resource that has transmitted the serving beams.

If large-scale characteristics of a channel transmitting a symbol on a first antenna port may be estimated from a channel transmitting a symbol on a second antenna port, the first antenna port and the second antenna port may be evaluated to be in the QCL relationship. For example, the large-scale characteristics may include at least one of a delay spread, a Doppler spread, a Doppler shift, an average gain, an average delay, and a spatial receiver parameter.

In FIG. 1, it has been described that both the base station 110 and the terminal 120 perform the beamforming, but embodiments of the disclosure are not necessarily limited thereto. In some embodiments, the terminal may or may not perform the beamforming. Also, the base station may or may not perform the beamforming. That is, only one of the base station and the terminal may perform the beamforming, or both the base station and the terminal may not perform the beamforming.

In the disclosure, a beam refers to a spatial flow of a signal in a wireless channel, and is formed by one or more antennas (or antenna elements), and this formation process may be referred to as beamforming. Beamforming may include at least one of analog beamforming or digital beamforming (e.g., precoding). A reference signal transmitted based on beamforming may include, for example, a demodulation-reference signal (DM-RS), a channel state information-reference signal (CSI-RS), a synchronization signal/physical broadcast channel (SS/PBCH), and a sounding reference signal (SRS). In addition, an IE such as CSI-RS resource or SRS-resource may be used as a configuration for each reference signal, and this configuration may include information associated with the beam. The information associated with the beam may mean whether a corresponding configuration (e.g., CSI-RS resource) uses the same spatial domain filter as another configuration (e.g., another CSI-RS resource within the same CSI-RS resource set) or a different spatial domain filter, or which reference signal it is quasi-co-located (QCL) with, and if so, what type it is (e.g., QCL type A, B, C, D).

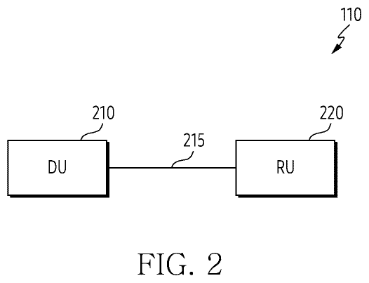

FIG. 2 illustrates a fronthaul interface according to an embodiment of the disclosure. Unlike a backhaul between a base station and a core network, the fronthaul refers to a section between entities between a radio access network (RAN) and a base station. FIG. 2 illustrates an example of a fronthaul structure between one DU 210 and one RU 220, but this is only for convenience of explanation and the disclosure is not limited thereto. In other words, the embodiments of the disclosure may also be applied to a fronthaul structure between one DU and a plurality of RU. For example, the embodiments of the disclosure may be applied to a fronthaul structure between one DU and two RU. In addition, the embodiments of the disclosure may also be applied to a fronthaul structure between one DU and three RU.

Referring to FIG. 2, the base station 110 may include a DU 210 and an RU 220. A fronthaul 215 between the DU 210 and the RU 220 may be operated via an Fx interface. For operation of the fronthaul 215, an interface such as an enhanced common public radio interface (eCPRI) or radio over ethernet (ROE) may be used.

As communication technology has been developed, mobile data traffic increased, and thus the bandwidth demand required in a fronthaul between a digital unit and a radio unit has increased significantly. In a deployment such as centralized/cloud radio access network (C-RAN), the DU may be implemented to perform functions for packet data convergence protocol (PDCP), radio link control (RLC), media access control (MAC), and physical (PHY), and the RU may be implemented to further perform functions for PHY layer in addition to a radio frequency (RF) function.

The DU 210 may be in charge of upper layer functions of a wireless network. For example, the DU 210 may perform functions of the MAC layer and a part of the PHY layer. Herein, a part of the PHY layer is a function performed at a higher level among the functions of the PHY layer, and may include, for example, channel encoding (or channel decoding), scrambling (or descrambling), modulation (or demodulation), and layer mapping (or layer demapping). According to an embodiment, if the DU 210 complies with an O-RAN standard, it may be referred to as an O-RAN DU (O-DU). The DU 210 may be replaced with and represented as a first network entity for a base station (e.g., gNB) in embodiments of the disclosure, as needed.

The RU 220 may be in charge of lower layer functions of a wireless network. For example, the RU 220 may perform a part of the PHY layer, and a RF function. Herein, a part of the PHY layer is a function performed at performed at a relatively lower level than the DU 210 among the functions of the PHY layer, and may include, for example, inverse fast Fourier transform (iFFT) conversion (or fast Fourier transform (FFT) conversion), CP insertion (CP removal), and digital beamforming. The RU 220 may be referred to as access unit (AU), access point (AP), transmission/reception point (TRP), remote radio head (RRH), radio unit (RU), or other terms having equivalent technical meanings. According to an embodiment, if the RU 220 complies with the O-RAN standard, it may be referred to as an O-RAN RU (O-RU). The RU 220 may be replaced with and represented as a second network entity for a base station (e.g., gNB) in embodiments of the disclosure, as needed.

Although FIG. 2 describes that the base station 110 includes the DU 210 and the RU 220, the embodiments of the disclosure are not limited thereto. The base station according to the embodiments may be implemented in a distributed deployment according to a centralized unit (CU) configured to perform functions of upper layers (e.g., packet data convergence protocol (PDCP), radio resource control (RRC)) of an access network and a distributed unit (DU) configured to perform functions of lower layers. At this time, the distributed unit (DU) may include the digital unit (DU) and the radio unit (RU) of FIG. 1. Between a core (e.g., 5^{th} generation core (5GC) or next generation core (NGC)) network and a radio access network (RAN), the base station may be implemented in a structure in which CU, DU, and RU are arranged in order. An interface between the CU and the distributed unit (DU) may be referred to as an F1 interface.

A centralized unit (CU) may be in charge of functions of a higher layer than the DU, by being connected to one or more DUs. For example, the CU may be in charge of radio resource control (RRC) and a function of a packet data convergence protocol (PDCP) layer, and the DU and the RU may be in charge of functions of lower layers. The DU may perform radio link control (RLC), media access control (MAC), and some functions (high PHY) of PHY layer, and the RU may perform remaining functions (low PHY) of the PHY layer. In addition, as an example, a digital unit (DU) may be included in a distributed unit (DU) according to the implementation of distributed deployment of the base station. Hereinafter, unless otherwise defined, it is described as operations of the digital unit (DU) and the RU, but various embodiments of the disclosure may be applied to both of a base station arrangement including the CU or an arrangement where the DU is directly connected to a core network (i.e., the CU and the DU are integrated into a base station (e.g., NG-RAN node) which is a single entity).

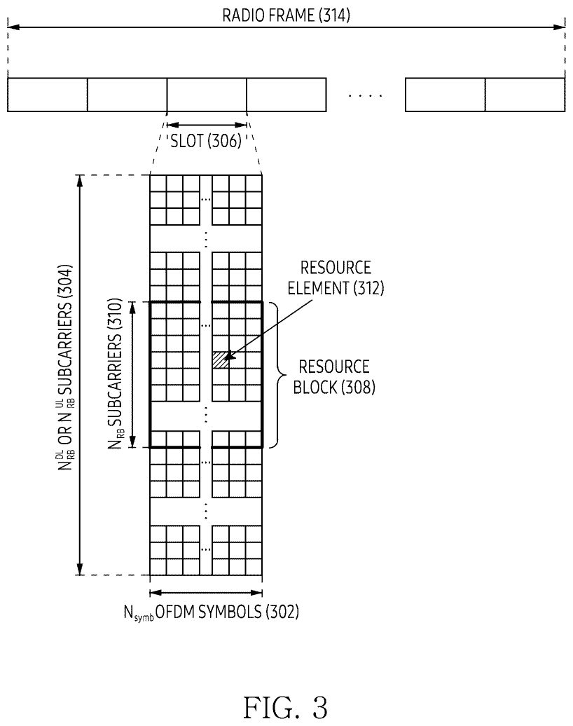

FIG. 3 illustrates an example of a resource structure in a time region and a frequency region according to an embodiment of the disclosure. FIG. 3 illustrates a basic structure of a time-frequency region, which is a radio resource region in which data or a control channel is transmitted in downlink or uplink.

Referring to FIG. 3, a horizontal axis indicates the time region and a vertical axis indicates the frequency region. A minimum transmission unit in the time region is an orthogonal frequency division multiplexing (OFDM) symbol, and N_{symb} OFDM symbols 302 constitute one slot 306. A length of a subframe is defined as 1.0 ms, and a length of a radio frame 314 is defined as 10 ms. A minimum transmission unit in the frequency region is a subcarrier, and a carrier bandwidth constituting a resource grid is composed of N_{RB}^{DL} (or N_{RB}^{UL}) subcarriers 304.

A basic unit of a resource in the time-frequency region is a resource element (hereinafter, ‘RE’) 312, which may be indicated by an OFDM symbol index and a subcarrier index. A resource block may include a plurality of resource elements. In an LTE system, a resource block (RB) (or a physical resource block, hereinafter, ‘PRB’) is defined as N_{symb} consecutive OFDM symbols in the time region and N_{SC}^{RB} consecutive subcarriers in the frequency region. In an NR system, a resource block (RB) 308 may be defined as N_{SC}^{RB} consecutive subcarriers 310 in the frequency region. One RB 308 includes N_{SC}^{RB} REs 312 in the frequency axis. In general, a minimum unit of transmission of data is an RB and the number of subcarriers, N_{SC}^{RB}, is 12. The frequency region may include common resource blocks (CRBs). A physical resource block (PRB) may be defined in a bandwidth part (BWP) on the frequency region. CRB and PRB numbers may be determined according to subcarrier spacing. A data rate may increase in proportion to the number of RBs scheduled for a terminal.

In an NR system, in a case of a frequency division duplex (FDD) system that operates by separating downlink and uplink by frequency, downlink transmission bandwidth and uplink transmission bandwidth may be different from each other. Channel bandwidth indicates radio frequency (RF) bandwidth corresponding to system transmission bandwidth. Table 1 illustrates a portion of a correspondence among system transmission bandwidth, subcarrier spacing (SCS), and channel bandwidth defined in an NR system in a frequency range lower than x GHz (e.g., a frequency range (FR) 1 (310 MHz to 7125 MHZ)). And Table 2 illustrates a portion of a correspondence among transmission bandwidth, subcarrier spacing (SCS), and channel bandwidth defined in the NR system in a frequency range higher than y GHz (e.g., an FR2 (24250 MHz-52600 MHZ) or an FR2-2 (52600 MHz to 71000 MHz)). For example, in an NR system having 100 MHz channel bandwidth at 30 kHz subcarrier spacing, transmission bandwidth is composed of 273 RBs. In Table 1 and Table 2, N/A may be a bandwidth-subcarrier combination not supported in an NR system.

TABLE 1

| | Channel bandwidth [MHz] | | | | | | |
|---|---|---|---|---|---|---|---|
| | SCS | 5 | 10 | 20 | 50 | 80 | 100 |
| Transmission | 15 kHz | 25 | 52 | 106 | 207 | N/A | N/A |
| bandwidth | 30 kHz | 11 | 24 | 51 | 133 | 217 | 273 |
| configuration N_{RB} | 60 kHz | N/A | 11 | 24 | 65 | 107 | 135 |

TABLE 2

| Channel bandwidth [MHz] | SCS | 50 | 100 | 200 | 400 |
|---|---|---|---|---|---|
| Transmission bandwidth | 60 kHz | 66 | 132 | 264 | N/A |
| configuration N_{RB} | 120 kHz | 32 | 66 | 132 | 264 |

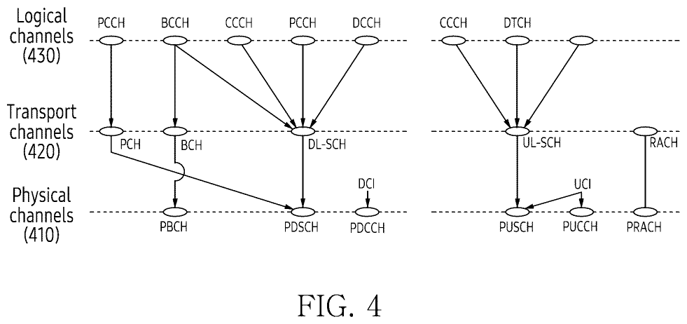

FIG. 4 illustrates an example of channels in a communication standard according to an embodiment of the disclosure. The channels may include a physical channel 410, a transport channel 420, and a logical channel 430 according to layers defined in the communication standard.

Referring to FIG. 4, the physical channel 410 may provide functions (e.g., channel coding, hybrid automatic request acknowledgement (HARQ) processing, modulation, multi-antenna processing, and resource mapping) necessary to generate physical signals in a physical layer. In the physical layer, the physical signals are modulated in an OFDM manner and may be transmitted in a wireless environment through a time-frequency resource (e.g., a resource in the resource grid of FIG. 3).

In downlink transmission, the physical channel 410 may include at least one of a physical broadcast channel (PBCH), a physical downlink shared channel (PDSCH), or a physical downlink control channel (PDCCH). The PDCCH may be used to carry downlink control information (DCI). In general, downlink data may refer to symbols transmitted through the PDSCH, and a downlink control signal may mean symbols transmitted through the PDCCH. In addition, in the downlink, besides the channels illustrated in FIG. 4, an SS/PBCH block, which includes a synchronization signal (e.g., a primary synchronization signal (PSS) and a secondary synchronization signal (SSS)) and a broadcast signal (e.g., PBCH), may be transmitted for synchronization. In addition, in the downlink, a channel state information-reference signal (CSI-RS) for measurement or obtaining channel information, a demodulation reference signal (DMRS) for channel estimation and demodulation, and a phase tracking reference signal (PTRS) may be transmitted.

In uplink transmission, the physical channel 410 may include at least one of a physical uplink shared channel (PUSCH), a physical uplink control channel (PUCCH), or a physical random access channel (PRACH). The PUSCH or PUCCH may be used to carry uplink control information (UCI). In general, uplink data may refer to symbols transmitted through the PUSCH, and an uplink control signal may mean symbols corresponding to the UCI. For example, the UCI may include at least one of a scheduling request (SR), a hybrid automatic request acknowledgement (HARQ-ACK) bit(s), or channel state information (CSI). In addition, in the uplink, besides the channels illustrated in FIG. 4, a DMRS and a PTRS for channel estimation and demodulation may be transmitted in the downlink for channel estimation.

The transport channel 420 may connect the physical layer and a medium access channel (MAC) layer positioned above the physical layer, and may be classified according to how data is transmitted through a radio interface. In the downlink, the transport channel 420 may include at least one of a paging channel (PCH) for paging, a broadcast channel (BCH) for broadcasting system information, and a downlink shared channel (DL-SCH) for transmission of downlink data. In the uplink, the transport channel 420 may include at least one of a random access channel (RACH) for transmission of random access preambles or an uplink shared channel (UL-SCH) for transmission of downlink data.

The logical channel 430 is positioned above a transport channel and is mapped to the transport channel 420. The logical channel 430 may be classified into a control channel for transmitting control region information and a traffic channel for transmitting user region information. The control channel of the logical channel 430 may include at least one of a paging control channel (PCCH), a broadcast control channel (BCCH), a common control channel (CCCH), or a dedicated control channel (DCCH). The traffic channel of the logical channel 430 may include a dedicated traffic channel (DTCH).

In describing embodiments of the disclosure, the term ‘data’ may mean sequences other than a reference signal. For example, ‘data’ obtained by a receiver in uplink communication may mean signals transmitted through the PUSCH. However, the PUSCH is merely exemplary, and embodiments of the disclosure may also be applied to other channels (e.g., PDSCH, PBCH, PDCCH, and PUCCH) that require channel estimation.

The disclosure relates to an electronic device and a method for improving reception performance by using a pre-whitening filter when receiving a signal in a wireless communication system. Specifically, the disclosure describes a technique for receiving a signal via a pre-whitening filter in a wideband mobile communication system. In particular, reception performance may be improved through the pre-whitening filter in an environment where an interference signal of a neighbor cell exists. According to interference of the neighbor cell, a whitening technique may be used adaptively.

Multiple-input multiple-output (MIMO) technology is a recently highlighted field in which active research is being conducted. Assume a situation where channels between transmission antennas and reception antennas are independent, the number of the transmission antennas and the number of reception antennas are both M, and a bandwidth and total transmission power are fixed. In this situation, the average channel capacity increases by about M times compared to a single antenna. For example, in a MIMO environment, a reception method may include minimum mean-square error (MMSE) or maximum ratio combine (MRC). In the disclosure, a whitening technique capable of improving the performance of a reception method (e.g., MMSE, MRC) based on both interference from other cells and adaptive white Gaussian noise (AWGN) during signal reception is described. In order to explain the above-described whitening technique, a reception situation of uplink transmission (e.g., PUSCH transmission) in an LTE communication system or an NR communication system is described as an example, but embodiments of the disclosure are not limited thereto. Even in a case of receiving signals according to other communication systems (e.g., Institute of Electrical and Electronics Engineers (IEEE) 802.11 or 802.16e), embodiments of the disclosure may be applied.

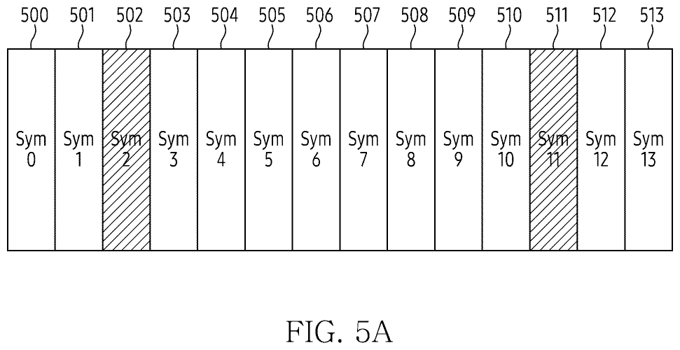

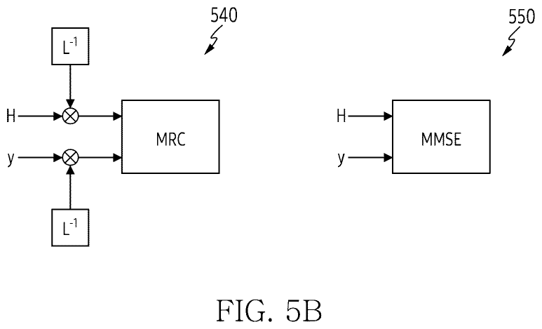

FIG. 5A illustrates an example of a demodulation reference signal (DMRS) within a slot according to an embodiment of the disclosure. The DMRS is a reference signal (RS) used to demodulate data. The DMRS may be used to estimate a channel for demodulating data (e.g., PDSCH, PUSCH) and obtain a result of the channel estimation. Hereinafter, in order to explain the channel estimation of the disclosure and operations using the DMRS for the channel estimation, an uplink transmission of an NR communication system is described as an example. However, the embodiments of the disclosure are not limited to the uplink of an NR communication system. The embodiments of the disclosure may be applied to a downlink or other communication systems.

Referring to FIG. 5A, a base station (e.g., the base station 110) may receive a signal from a terminal (e.g., the terminal 120). The terminal 120 may transmit an uplink signal to the base station 110. The received signal may include data (hereinafter, reception data) received on an uplink channel (e.g., PUSCH). The reception data may be transmitted in data symbols in a time domain. In addition, the received signal may include reference signals (hereinafter, reception reference signals) (e.g., DMRS) for channel estimation and coherent demodulation of the data symbols. The reception reference signals may be transmitted in DMRS symbols in the time domain. The base station 110 may receive, from the terminal 120, the reception data in the data symbols of the slot and the reception reference signals in the DMRS symbols. The slot may include 14 symbols (e.g., symbol #0 (500), symbol #1 (501), symbol #2 (502), symbol #3 (503), symbol #4 (504), symbol #5 (505), symbol #6 (506), symbol #7 (507), symbol #8 (508), symbol #9 (509), symbol #10 (510), symbol #11 (511), symbol #12 (512), and symbol #13 (513)). At least some of the 14 symbols may be used to carry DMRS sequences. For example, an interval of the symbol #2 (502) and an interval of the symbol #11 (511) may include DMRS symbols.

The base station 110 may estimate a channel between the base station 110 and the terminal 120 through the reception reference signals. The base station 110 may obtain information on a channel experienced by the reception reference signals. For example, the base station 110 may obtain information on a channel experienced by the reception data through a relationship between a position where DMRS symbols of the reception reference signals are mapped and positions where data symbols of the reception data are mapped. For example, the base station 110 may obtain information on the channel experienced by the reception data by performing interpolation in a frequency domain or interpolation in a time domain, based on the information on the channel experienced by the reception reference signals. However, since the number of data symbols in one slot, which is a transmission unit, is generally greater than the number of DMRS symbols, an operation of estimating channels experienced by each data symbol may require a large amount of computation. In addition, since the computation of the DMRS symbols themselves or the interference between cells is not reflected, the reception performance may not be guaranteed. To this end, the base station 110, which is a receiving end, may utilize various reception techniques.

An estimation signal for a data signal may be obtained by applying a signal combining technique to reception signals received through a plurality of reception antennas. For example, the signal combining technique may include maximal ratio combining (MRC), selective combining, or equal gain combining. The MRC technique is a method of combining data by giving weights to each data. The selective combining technique is a method of selectively combining data, and the equal gain combining technique is a method of giving equal weights to each data and combining them through an average value.

The MRC technique is one of reception techniques that utilizes a diversity of signals received through multiple paths in a system using multiple antennas, and it is known to show optimal performance in a noise-limited environment with a high signal to interference plus noise ratio (SINR). However, an estimation signal obtained by using the MRC technique does not consider the influence of an interference signal from a neighbor cell. In addition, in an actual multi-cell environment, a terminal located at a cell boundary is affected by the neighbor cell and has a low SINR. Therefore, a terminal located at a cell boundary in the multi-cell environment may not be able to achieve optimal performance using the MRC technique. In a cellular system (e.g., a long term evolution (LTE) communication system or a new radio (NR) communication system of the 3rd Generation Partnership Project (3GPP)), not only AWGN but also interference from other cells may exist. A noise component may include the interference from AWGN and other cells. In an environment where the interference exists, the performance of an MRC receiver using whitening is superior to that of a general MRC receiver. Conversely, in an environment where there is no interference, the performance of the MRC receiver using whitening is the same as that of the general MRC receiver. However, for implementation reasons, the performance of the MRC receiver using whitening may be degraded compared to that of the general MRC receiver. Hereinafter, the MRC receiver using whitening may have a structure in which a whitening matrix application block is added to the MRC receiver to receive a signal, like the MMSE method.

FIG. 5B is a diagram for explaining a principle of whitening according to an embodiment of the disclosure.

Referring to FIG. 5B, an MRC receiver 540 or an MMSE receiver 550 may obtain an actual received signal y (hereinafter, reception signal) and an actual transmitted signal (hereinafter, transmission signal) based on a channel estimation result H. A relationship between the transmission signal and the reception signal may be expressed as follows.

$$y = hs + i + n \qquad Equation 1$$

Herein, s indicates a transmission signal, y indicates a reception signal, h indicates a channel, i indicates an interference component, and n indicates a noise component. If FFT is applied to a time domain signal, the equation may be converted into the following frequency domain equation.

$$y = Hx + {H}_{I} I + N \qquad Equation 2$$

Herein, y indicates a reception signal, H indicates a channel between a transmission end and a receiving end, x indicates a transmission signal, I indicates an interference component, N indicates a noise component, and HI indicates a channel between another transmission end affecting the interference and a receiving end.

If a receiving end (e.g., the base station 110 in uplink transmission) receives a signal in the MMSE method, the receiving end may generate a weight for applying the MMSE. For example, the weight for applying the MMSE, that is a weight (W) of the optimal MMSE combiner, may be derived based on the following equation.

$$\hat{x} = Wy \qquad Equation 3$$

$$Equation 4$$

$${\vert x - \hat{x} \vert}^{2} = {\vert x - Wy \vert}^{2} = ( x - Wy ) {( x - Wy )}^{H} = ( x - Wy ) ( {x}^{H} - {y}^{H} {W}^{H} )$$

The subscript ‘H’ denotes a conjugate transpose matrix.

$$\frac{\partial g [ {\vert x - Wy \vert}^{2} ]}{\partial {W}^{H}} = \frac{\partial g [ {xx}^{H} - {Wyx}^{H} - {xy}^{H} {W}^{H} + {Wyy}^{H} {W}^{H} ]}{\partial {W}^{H}} = E [ - {xy}^{H} + {Wyy}^{H} ] = 0 \qquad Equation 5$$

According to a result of Equation 5, W may be determined based on the following equation. Herein, a third equality may be derived through a matrix inversion lemma.

$$W = E [ {xy}^{H} ] {E [ {yy}^{H} ]}^{- 1} = {H}^{H} {R}_{yy}^{- 1} = {H}^{H} {R}_{nn}^{- 1} \qquad Equation 6$$

Rₙₙ is an auto-covariance matrix of a noise component and an interference component, and may be represented by the following equation through Cholesky decomposition.

$${R}_{nn} = E [ {nn}^{H} ] = {LL}^{H} \qquad Equation 7$$

Herein, n indicates a sum of an interference component (N) and a noise component (I), and L denotes an inverse of a whitening matrix to be applied in a pre-whitening filter.

If the MMSE weight W is applied to the reception signal y, a signal according to the application result may be expressed by the following equation.

$$Equation 8$$

$$Wy = {H}^{H} {R}_{nn}^{- 1} y = {{H}^{H} ( {LL}^{H} )}^{- 1} y = {{H}^{H} ( {L}^{H} )}^{- 1} {( L )}^{- 1} y = {( {L}^{- 1} H )}^{H} {( L )}^{- 1} y$$

In general, the weight W_{mrc} of an MRC receiver is as follows.

$${W}_{mrc} = {H}^{H} \qquad Equation 9$$

Referring to Equation 8 and Equation 9, a channel H′ obtained by applying whitening may be represented as L⁻¹H, and a reception signal y′ obtained by applying whitening may be represented as (L)⁻¹y

$$Wy = {( {L}^{- 1} H )}^{H} {( L )}^{- 1} y = {( {H}^{′} )}^{H} {y}^{′} \qquad Equation 10$$

Hereinafter, in the embodiments of the disclosure, whitening may include an operation of applying an L⁻¹ matrix. Since whitening is applied before calculation of a receiver, a calculation of whitening may be understood as an operation of a pre-whitening filter. That is, the receiver 550 for MMSE may be equivalently represented as the MRC receiver 540 for a whitening-applied channel and a whitening-applied reception signal. Therefore, if L⁻¹ is referred to as a pre-whitening filter, it may be understood that the MRC receiver 540 to which whitening is applied is equivalent to the MMSE receiver 550.

In order to apply whitening, that is, to calculate a whitening matrix L⁻¹ to be applied to a filter, Rₙₙ is required to be accurately calculated. However, if many pilots (or RSs) are used to accurately obtain Rₙₙ, one value is derived over a wide bandwidth. If the same interference is distributed over a frequency band, it may have no effect on the performance of the receiver, but if other interference characteristics are distributed in the frequency band, degradation in receiver performance may occur. Therefore, it is required to calculate Rₙₙ⁻¹ in units are expected to have similar interference amounts. When interference exists, the receiver performance is improved, but when interference does not exist, the receiver performance may be degraded because an off-diagonal term does not fully converge to zero when calculating Rₙₙ⁻¹. Accordingly, the receiver performance when the interference does not exist may converge to the performance of ML when

$${R}_{nn}^{- 1}$$

is accurately calculated.

In order to obtain the whitening matrix L⁻¹, it is required to calculate Rₙₙ. Rₙₙ is an auto-covariance matrix of a noise-and-interference power, and the mean in Equation 7, a frequency average may be used instead of an ensemble average. Rₙₙ may be approximated as shown in the following equation.

$${R}_{nn} = E [ {nn}^{H} ] \approx < {nn}^{H} > \qquad Equation 11$$

$$< {nn}^{H} {>}_{kn} = \frac{1}{{N}_{used}} {\sum }_{i = 0}^{{N}_{used} - 1} {n}_{k} ( i ) {n}_{m}^{*} ( i ) \qquad Equation 12$$

Rₙₙ is Nₐₙₜ×Nₐₙₜ Matrix and N_{used} is the number of RS symbols in the whitening units.

Meanwhile, in some embodiments, before converting Rₙₙ into the form of LL^{H} through Cholesky decomposition and calculating L⁻¹, the following process may be added.

$${R}_{n}^{new} = {R}_{nn} + k \cdot I \qquad Equation 13$$

Herein, I is an Nₐₙₜ×Nₐₙₜ Identity matrix. The addition of the above process facilitates Cholesky decomposition and the subsequent calculation according to a condition of Rₙₙ in actual implementation. The degree of whitening may be adjusted according to k. As a value of k increases, a value of the diagonal term of Rₙₙ becomes relatively larger than a value of the off-diagonal term, and

$${R}_{nn}^{new}$$

may become closer to an identity matrix. If Rₙₙ becomes the identity matrix, L⁻¹ also becomes the identity matrix and may function the same as the MRC receiver.

According to an embodiment, a value of k may be adjusted by measuring an amount of interference and comparing it with a specific reference value. That is, if the interference amount is small and the MRC performance is superior to the MMSE performance, the effect of turning off the whitening function may be achieved by setting a size of k to a large value. Conversely, if the interference amount is large and the MMSE performance is superior to the MRC performance, so the minimum k required for implementation may be set. In addition to the interference amount, other parameters (e.g., carrier-to-interference-plus-noise ratio (CINR), signal-to-interference-plus-noise ratio (SINR)) may be used as the criterion for turning the whitening function on/off. In addition, it may be understood as an embodiment of the disclosure that, in addition to the method of determining the value, k value, Rₙₙ is transformed in another way to make Rₙₙ similar to the Identity matrix, thereby reducing the effect of MMSE and making it operate like the MRC. In addition, it may also be understood as an embodiment of the disclosure to replace L⁻¹ with the identity matrix and make it operate like the MRC.

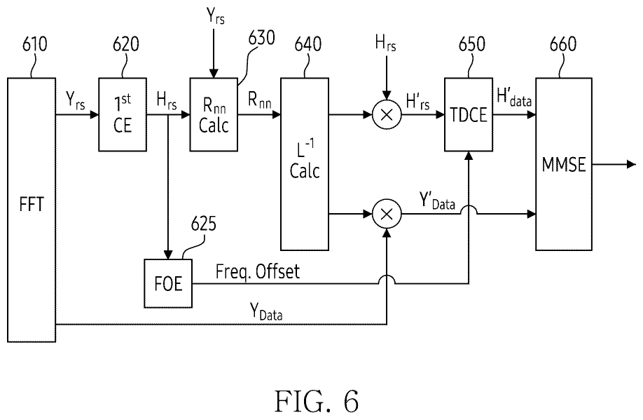

FIG. 6 illustrates an example of a functional block of data channel estimation using whitening for a reference signal (RS) channel according to an embodiment of the disclosure. The terms ‘ . . . unit’, ‘ . . . er’, and the like used below mean a unit that processes at least one function or operation, and may be implemented by hardware, software, or a combination of hardware and software.

Referring to FIG. 6, the receiver may include an FFT unit 610, a first channel estimation unit 620, a frequency offset application unit 625, an Rₙₙ calculation unit 630, a whitening filter unit 640, a time domain channel estimation (TDCE) unit 650, and an MMSE application unit 660.

If the received reception signal of the time domain is y, then after the time-frequency conversion in the FFT unit 610, the reception signal of the frequency domain may be expressed as Y. The reception signal may include reception data (e.g., PUSCH signal) and reception reference signals (e.g., DMRSs) for channel estimation and demodulation. The reception reference signals may be expressed as Yᵣₛ. The reception data refer to as Y_{data}.

The first channel estimation unit 620 may perform channel estimation for reception reference signals (e.g., DMRSs). For example, the first channel estimation unit 620 may perform channel estimation using Yᵣₛ.

$${H}_{rs} = {f}_{ce} ( {Y}_{rs} ) \qquad Equation 14$$

Herein, f_{cs} denotes a channel estimation function. Hᵣₛ denotes a wireless channel experienced by the reception reference signals. Hᵣₛ may correspond to a result of channel estimation for the reception reference signals. The first channel estimation unit 620 may provide the result of the channel estimation to each of the frequency offset application unit 625 and the Rₙₙ calculation unit 630.

The frequency offset application unit 625 may provide a frequency offset to the TDCE unit 650, based on the result of the channel estimation.

The Rₙₙ calculation unit 630 may calculate Rₙₙ, based on the reception reference signals (e.g., actual received DMRSs) Yᵣₛ and a predetermined sequence (e.g., DMRS sequence of LTE or NR standard). Rₙₙ is an auto-covariance matrix of a noise component and an interference component. For example, the Rₙₙ calculation unit 630 may calculate Rₙₙ, based on the following equation.

$${n}_{k} ( i ) = {Y}_{rs} ( i ) - {H}_{rs} ( i ) \cdot X ( i ) \qquad Equation 15$$

nₖ(i) is the noise component in the i-th subcarrier, and x(i) denotes a sequence (e.g., DMRS sequence) in the i-th subcarrier.

The Rₙₙ calculation unit 630 may provide the calculated Rₙₙ to the whitening filter unit 640.

The whitening filter unit 640 may calculate a pre-filter matrix L⁻¹ suitable for the receiver. The pre-filter matrix may be referred to as a whitening filter or a whitening matrix. For example, the whitening filter unit 640 may calculate the whitening matrix L⁻¹, based on the Cholesky decomposition of the covariance matrix of the noise-and-interference component as described through Equation 7 to Equation 9. The whitening filter unit 640 may calculate the whitening matrix L⁻¹ to be applied to a result Hᵣₛ of channel estimation for the reception reference signals and the received reception data Y_{Data}. The whitening filter unit 640 may output the calculated whitening matrix L⁻¹. For example, the whitening filter unit 640 may provide the calculated whitening matrix L⁻¹ to a multiplier of the result Hᵣₛ of the channel estimation. In addition, for example, the whitening filter unit 640 may provide the calculated whitening matrix L⁻¹ to the multiplier of the reception data Y_{Data}. If the whitening matrix L⁻¹ is applied to the result Hᵣₛ of the channel estimation, the receiver may obtain first whitening channel estimation information Hᵣₛ′ for the reception reference signals. For example, the first whitening channel estimation information Hᵣₛ′ may be derived based on the following equation.

$${H}_{rs ( k )}^{′} = {L}^{- 1} \cdot {H}_{rs ( k )} \qquad Equation 16$$

Hᵣₛ′ is the channel matrix obtained by applying whitening, that is, the first whitening channel estimation information, and L⁻¹ is the inverse of L, which is the Cholesky decomposition component of the covariance matrix. Herein, k is the DMRS symbol index, and if two reception reference signals are assigned to one slot, k may be 0 or 1.

The TDCE unit 650 may obtain second whitening channel estimation information H_{data}′, which is the channel estimation information to be applied to the reception data Y_{Data}, based on the first whitening channel estimation information Hᵣₛ′ and a frequency offset. For example, the TDCE unit 650 may convert the first whitening channel estimation information Hᵣₛ′, based on a resource location (e.g., time-frequency resource, resource element (RE)) to which the reception data is mapped and a interpolation technique. The TDCE unit 650 may estimate a channel that the data corresponding to the resource location has experienced, based on the first whitening channel estimation information Hᵣₛ′. For example, the second whitening channel estimation information H_{data}′ may be derived based on the following Equation. A situation where two RS symbols are applied (e.g., the symbols in FIG. 5A) is exemplified.

$${H}_{data ( k )}^{′} = {w}_{0 , k} \cdot {H}_{rs 0}^{′} + {w}_{1 , k} \cdot {H}_{rs 1}^{′} \qquad Equation 17$$

H′ᵣₛ₀ is a result of applying a whitening matrix to a channel estimated through a first DMRS symbol (e.g., the DMRS symbol of symbol #2 (502)) (hereinafter, a first RS whitening channel), and H′ᵣₛ₁ is a result of applying a whitening matrix to a channel estimated through a second DMRS symbol (e.g., the DMRS symbol of symbol #11 (511)) (hereinafter, a second RS whitening channel). H′_{data(k)} is the estimated channel for the k-th data symbol in the whitening-applied situation. Wok denotes a first weight to be applied to the first RS whitening channel for the k-th data symbol. w_{1,k} denotes a second weight to be applied to the second RS whitening channel for the k-th data symbol. As an example, k may be 0, 1, 2, 3, . . . , 11 as a data symbol.

Since the data channel estimated through the above methods is obtained by performing channel estimation in a state where whitening has already been applied, the complexity may be reduced. For comparison, a situation where whitening is performed after performing channel estimation for data symbols that is a conventional method, will be examined. For example, the channel estimation for data symbol #k may be performed as follows.

$${H}_{data ( k )} = {w}_{0 , k} \cdot {H}_{rs 0} + {w}_{1 , k} \cdot {H}_{rs 1} \qquad Equation 18$$

$${H}_{data ( k )}^{′} = {L}^{- 1} \cdot {H}_{data ( k )}$$

Hᵣₛ₀ is a channel (hereinafter, the first RS channel) estimated through the first DMRS symbol (e.g., the DMRS symbol of symbol #2 (502)), and Hᵣₛ₁ is a channel (hereinafter, the second RS channel) estimated through the second DMRS symbol (e.g., the DMRS symbol of symbol #11 (511)). w_{0,k} denotes a first weight to be applied to the first RS channel for the k-th data symbol. w_{1,k} denotes a second weight to be applied to the second RS channel for the k-th data symbol. For example, k may be 0, 1, 2, 3, . . . , 11 as a data symbol.

If channel estimation for reception data is performed after applying a whitening matrix to a channel estimation result using reception reference signals, the actual number of whitening calculations is two. This is because the whitening effect has already been reflected through an RS whitening channel to which weights are to be applied (e.g., the first RS whitening channel and the second RS whitening channel). However, as shown in Equation 18, if whitening is applied to each symbol after performing channel estimation for reception data, the total number of whitening calculations is twelve. Therefore, since the number of whitening calculations is reduced by up to one-sixth, the overall computational complexity may be reduced.

In the method of Equation 18, after performing channel estimation for each symbol in the antenna domain, whitening is performed. However, the receiver according to the embodiments of the disclosure may perform whitening on a channel estimated through reception reference signals, move from the antenna domain to the beam domain, and perform channel estimation for reception data in the beam domain. Through this, the amount of computation may be reduced.

Based on the above-described results, the TDCE unit 650 may provide the second whitening channel estimation information H_{data}′ to the MMSE application unit 660. The MMSE application unit 660 may obtain transmission data corresponding to the reception data Y_{Data}, based on the second whitening channel estimation information H_{data}′. For example, the MMSE application unit 660 may obtain a signal (hereinafter, transmission signal) (e.g., x) originally transmitted from the transmitter, by reversely applying the second whitening channel estimation information H_{data}′.

The matrix inversion lemma is as follows.

$${( A + {BB}^{H} )}^{- 1} = {A}^{- 1} - {A}^{- 1} B {( I + {B}^{H} {A}^{- 1} B )}^{- 1} {B}^{H} {A}^{- 1} \qquad Equation 19$$

An equalization matrix for MMSE may be developed as follows according to the matrix inversion lemma.

$${Wy = {{H}^{H} ( {HH}^{R} + {R}_{nn} )}^{- 1} y = {H}^{H} {R}_{nn}^{- 1} y - {H}^{H} {R}_{nn}^{- 1} H 〈 {H}^{H} {R}_{nn}^{- 1} H + 1 )}^{- 1} {H}^{H} {R}_{nn}^{- 1} y \qquad Equation 20$$

$$= {( {H}^{H} {R}_{nn}^{- 1} H + 1 )}^{- 1} {H}^{H} {R}_{nn}^{- 1} y$$

If the result of the equation is distinguished into \tilde{w}, which is an effective channel of MRC, and a pre-filter matrix (i.e., a pre-whitening matrix) B⁻¹, it may be represented by the following equation.

$${( {H}^{H} {R}_{nn}^{- 1} H + I )}^{- 1} {H}^{H} {R}_{nn}^{- 1} y = \tilde{W} = {B}^{- 1} y , where \tilde{W} = {B}^{- 1} {H ( {H}^{H} {R}_{nn}^{- 1} H + I )}^{- 1} \qquad Equation 21$$

Herein, B=L according to Cholesky decomposition may be applied to the pre-filter matrix in the above equation. In this case, the effective channel of the above equation may be represented by the following equation.

$${{\tilde{W} = {L}^{- 1} H ( {H}^{H} ( {LL}^{H} ]}^{- 1} H + I )}^{- 1} = ( {L}^{- 1} H ) {( {( {L}^{- 1} H )}^{H} {L}^{- 1} H + 1 )}^{- 1} \qquad Equation 22$$

From the above equation, it may be identified that the effective channel to be applied to the MMSE receiver is L⁻¹H. That is, through the MRC channel estimation technique to which whitening is applied, an MRC receiver for a whitening-applied channel and a whitening-applied reception signal may be used for the MMSE channel estimation.

Meanwhile, as another embodiment, the Equation 20 may be rewritten as the following Equation. The effective channel of MRC may be \tilde{w}, and the pre-filter matrix may be

$${R}_{nn}^{- 1} H .$$

$$W = E [ {Xy}^{H} ] {E [ {yy}^{H} ]}^{- 1} = {H}^{H} {R}_{nn}^{- 1} = {{H}^{H} ( {HH}^{H} + {R}_{nn} )}^{- 1} y = {H}^{H} {R}_{nn}^{- 1} y - \qquad Equation 23$$

$${H}^{H} {R}_{nn}^{- 1} {H ( {H}^{H} {R}_{n n}^{- 1} H + I )}^{- 1} {H}^{H} {R}_{nn}^{- 1} y = {( {H}^{H} {R}_{nn}^{- 1} H + I )}^{- 1} {H}^{H} {R}_{nn}^{- 1} y = {\tilde{W}}^{H} y ,$$

$$where \tilde{W} = {R}_{nn}^{- 1} {H ( {H}^{H} {R}_{nn}^{- 1} H + I )}^{- 1}$$

In the embodiments of the disclosure, the proposed method requires that received frequency offsets between antennas be the same. For example, since the reception antennas with different RUs of the base station have different frequency oscillators, LLR combining should be performed instead of antenna combining. However, since such LLR combining is difficult to calculate through interpolation or weight multiplication, it is difficult to estimate the channel for reception data from the channel estimated using the reception reference signals. Therefore, in embodiments of the disclosure, in a case that frequency offsets between reception antennas are the same in a situation that the base station or the RU of the base station is identical, a channel estimation result Hᵣₛ for reception reference signals may be whitened first to calculate first whitening channel estimation information Hᵣₛ′, and second whitening channel estimation information H′_{data} may be calculated from the first whitening channel estimation information Hᵣₛ′ through the TDCE unit 650.

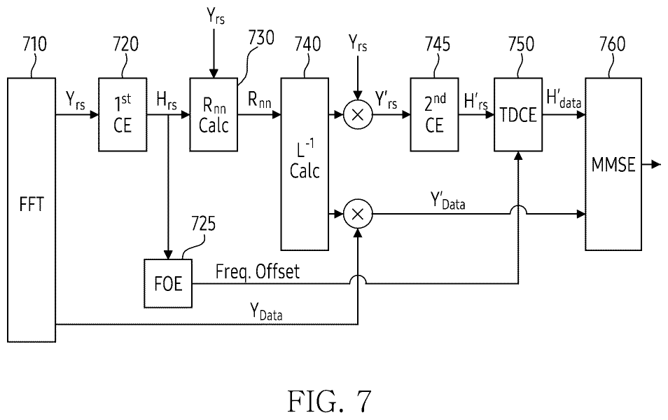

FIG. 7 illustrates an example of a functional block of data channel estimation using whitening for a received signal according to an embodiment of the disclosure. The terms ‘ . . . unit’, ‘ . . . er’, and the like used below refer to a unit that processes at least one function or operation, and may be implemented by hardware, software, or a combination of hardware and software.

Referring to FIG. 7, the receiver may include an FFT unit 710, a first channel estimation unit 720, a frequency offset application unit 725, an Rₙₙ calculation unit 730, a whitening filter unit 740, a second channel estimation unit 745, a time domain channel estimation unit 750, and an MMSE application unit 760.

The FFT unit 710 may correspond to the FFT unit 610 of FIG. 6. The first channel estimation unit 720 may correspond to the first channel estimation unit 620 of FIG. 6. The frequency offset application unit 725 may correspond to the frequency offset application unit 625 of FIG. 6. The Run calculation unit 730 may correspond to the Rₙₙ calculation unit 630 of FIG. 6. The whitening filter unit 740 may correspond to the whitening filter unit 640 of FIG. 6. The time domain channel estimation unit 750 may correspond to the time domain channel estimation unit 650 of FIG. 6. The MMSE application unit 760 may correspond to the MMSE application unit 660 of FIG. 6.

Unlike the receiver of FIG. 6, the whitening filter unit 740 of the receiver of FIG. 7 may apply a whitening matrix to the received reference signals, that is, reception reference signals, rather than the estimated channel. If the whitening matrix L⁻¹ for the reception reference signals is applied, the receiver may obtain the whitening reference signals Yᵣₛ′ for the reception reference signals. That is, the receiver may apply whitening to the received reference signals (e.g., DMRS symbols) instead of applying it to the estimated channel. Unlike the receiver of FIG. 6, the receiver of FIG. 7 may further include the second channel estimation unit 745. Thereafter, the whitening reference signals Yᵣₛ′ may be inputted to the second channel estimation unit 745.

The second channel estimation unit 745 may perform channel estimation based on whitening reference signals Yᵣₛ′. The second channel estimation unit 745 may obtain first whitening channel estimation information Hᵣₛ′ for reception reference signals. For example, the first whitening channel estimation information Hᵣₛ′ may be derived based on the following equation.

$${H}_{rs}^{′} = {f}_{ce} ( {Y}_{rs}^{′} ) \qquad Equation 24$$

H′ᵣₐ refers to a channel to which whitening is applied, that is, the whitening channel estimation information, and Y′ᵣₛ refers to the whitening reference signals Yᵣₛ′. f_{ce} refers to the channel estimation function.

The second channel estimation unit 745 may provide the estimated channel to the TDCE unit 650. The TDCE unit 750 may obtain second whitening channel estimation information H_{data}′, which is channel estimation information to be applied to reception data Y_{Data}, based on the first whitening channel estimation information Hᵣₛ′ and a frequency offset. For computational operations of the TDCE unit 750, calculations of equation 17 to equation 18 and operations of the TDCE unit 650 may be referred to. As channel estimation is performed in beam units after conversion from the antenna domain to the beam domain through whitening, the amount of computation may be reduced.

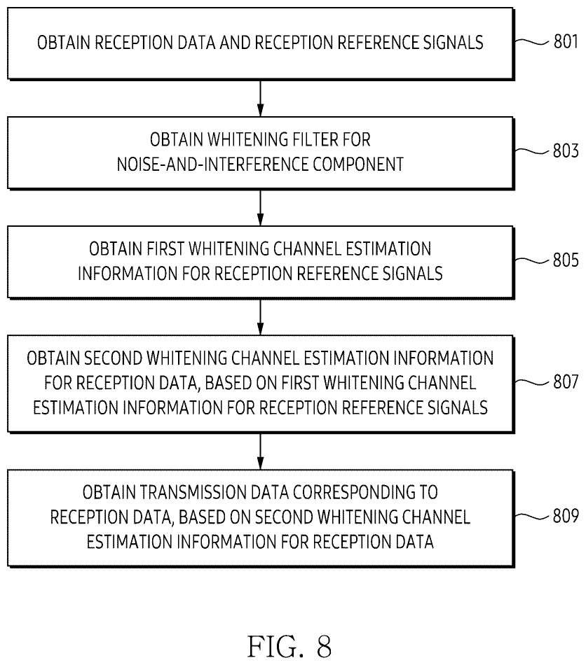

FIG. 8 illustrates an operation flow of an electronic device (e.g., the base station 110) for performing data channel estimation using whitening according to an embodiment of the disclosure.

Referring to FIG. 8, in operation 801, the electronic device may obtain reception data and reception reference signals. The electronic device may receive a signal from another electronic device (e.g., the terminal 120) through a wireless channel. The received signal may include reception data and reception reference signals. The other electronic device may transmit transmission data and transmission reference signals to the electronic device. The reception data may correspond to the transmission data passing through the wireless channel. The reception reference signals may be the transmission reference signals passing through the wireless channel. The reception data may be received over data symbols in the time domain. The reception reference signals may be received over DMRS symbols in the time domain.

In operation 803, the electronic device may obtain a whitening filter for a noise-and-interference component. In the disclosure, a whitening filter may be used to reduce the influence due to interference from a neighbor cell. The electronic device may obtain a whitening matrix of a whitening filter. In order to obtain the whitening filter, the electronic device may first estimate a channel experienced by reference signals received from the other electronic device. The electronic device may obtain a noise-and-interference component based on the estimated channel. The electronic device may obtain the whitening filter, based on a covariance matrix for the noise-and-interference component. For example, the electronic device may perform Cholesky decomposition of the covariance matrix. The electronic device may obtain a lower triangular matrix (e.g., I in Equation 7) of the covariance matrix via the Cholesky decomposition. The electronic device can determine an inverse of the lower triangular matrix as a whitening matrix of the whitening filter.

In operation 805, the electronic device may obtain first whitening channel estimation information for reception reference signals. In order to achieve a low-complexity whitening effect, the electronic device may obtain an RS channel to which a whitening filter is applied. According to an embodiment, the electronic device may estimate an RS channel (e.g., Hᵣₛ of FIG. 6), based on the reception reference signals. The electronic device may apply the whitening filter to the estimated RS channel. For example, the electronic device may obtain the first whitening channel estimation information (e.g., Hᵣₛ of FIG. 6) by multiplying the estimated RS channel by a whitening matrix of the whitening filter. For a functional configuration of the electronic device, the description of FIG. 6 may be referred to.

According to an embodiment, the electronic device may apply the whitening filter to the reception reference signals. For example, the electronic device may obtain whitening reference signals (e.g., Yᵣₛ′ of FIG. 7) by multiplying the reception reference signals by the whitening matrix of the whitening filter. The electronic device may obtain the first whitening channel estimation information (e.g., Hᵣₛ′ of FIG. 7) by performing channel estimation based on the whitening reference signals. For a functional configuration of the electronic device, the description of FIG. 7 may be referred to.

In operation 807, the electronic device may obtain second whitening channel estimation information for reception data, based on first whitening channel estimation information for reception reference signals. For example, the reception reference signals may include a first reception reference signal and a second reception reference signal. The first whitening channel estimation information may include information on a first RS whitening channel estimated through the first reception reference signal. The first RS whitening channel means a channel to which the whitening filter is applied to a channel of the first reception reference signal. The first whitening channel estimation information may include information on a second RS whitening channel estimated through the second reception reference signal. The second RS whitening channel means a channel to which the whitening filter is applied to a channel of the second reception reference signal.

The resources of the reception reference signals are different from the resources of the reception data. That is, a wireless channel experienced by the transmission data and the transmission reference signals may have different channel characteristics for each resource location (e.g., time-frequency resource location, RE). Accordingly, the electronic device may obtain a data channel (e.g., second whitening channel estimation information: H_{data}′) for reception data, based on the first whitening channel estimation information Hᵣₛ′ obtained through the reception reference signals. The electronic device may obtain the second whitening channel estimation information for the reception data, based on the first RS whitening channel and the second RS whitening channel. For example, the second whitening channel estimation information for the reception data may include a whitening data channel in data symbols. At this time, the electronic device can determine a first weight of the first RS whitening channel for the data symbols. The electronic device may determine a second weight of the second RS whitening channel for the data symbols. The electronic device may obtain a whitening data channel in the data symbols, by reflecting the first weight to the first RS whitening channel and the second weight to the second RS whitening channel. According to an embodiment, information on a frequency offset between reception antennas of the electronic device may be used to compensate for a positional difference between different resources. Additionally, according to an embodiment, an interpolation technique may be used for the positional difference between different resources.

Meanwhile, operations according to two reception reference signals are exemplary, and the reception reference signals may be understood as an embodiment of the disclosure as data channel estimation through one reception reference signal (e.g., one DMRS symbol) or three or more reception reference signals (e.g., three or more DMRS symbols), in accordance with the configuration.

In operation 809, the electronic device may obtain transmission data corresponding to reception data, based on second whitening channel estimation information for the reception data. The electronic device may obtain whitening data by applying the whitening filter to the reception data. The electronic device may obtain transmission data corresponding to the reception data, based on the whitening data and the second whitening channel information.

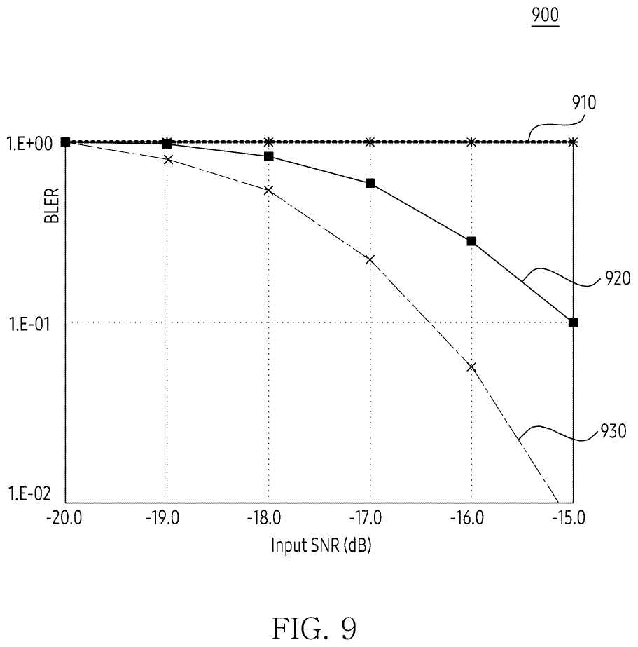

FIG. 9 illustrates an example of a performance graph of data channel estimation using whitening according to an embodiment of the disclosure. The data channel estimation refers to an operation of obtaining a wireless channel experienced by data symbols.

Referring to FIG. 9, a graph 900 represents the channel estimation performance. The horizontal axis of the graph 900 represents an input signal to noise ratio (SNR) (unit: decibel (dB)), and the vertical axis of the graph 900 represents a block error rate (BLER). A lower BLER indicates better performance. A line 910 represents the performance of data channel estimation without whitening. Based on a channel estimated using reception reference signals (e.g., DMRSs), a channel for reception data (e.g., PUSCH) is estimated. A line 920 represents the performance of data channel estimation according to a scheme (hereinafter, a first scheme) in which whitening is applied to the estimated channel using reception reference signals (e.g., DMRSs). According to the first scheme, a channel for reception data (e.g., PUSCH) is estimated based on the RS channel to which whitening is applied. In order to explain the operation of the first scheme, the receiver of FIG. 6 and the descriptions of the receiver may be referred to. A line 930 represents the performance of data channel estimation according to a scheme (hereinafter, a second method) in which whitening is applied to reception reference signals (e.g., DMRSs). According to the second scheme, a channel for reception data (e.g., PUSCH) is estimated based on reception reference signals to which whitening is applied. In order to explain the operation of the second scheme, the receiver of FIG. 7 and the descriptions of the receiver may be referred to.

Referring to the graph 900, it may be identified that the BLER performance of the second scheme is better than the BLER performance of the first scheme or the BLER performance of a scheme not using whitening. In addition, it may be identified that the BLER performance of the first scheme is better than the BLER performance of the scheme not using whitening. In the second scheme, since the whitening effect is applied not only to the reception data but also to the reception reference signals, the performance of the second scheme may be higher than the reception performance of the first scheme, in which the whitening effect is applied only to the reception data. However, since the first scheme does not perform additional channel estimation (i.e., the second channel estimation unit 745 such as the receiver of FIG. 7 is not required), the computational complexity of the first scheme may be lower than that of the second scheme. According to an embodiment, the receiver may use only the first scheme, only the second scheme, or may adaptively use both the first scheme and the second scheme.

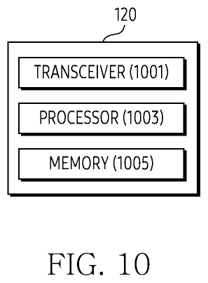

FIG. 10 illustrates a functional configuration of a terminal (e.g., the terminal 120) according to an embodiment of the disclosure. When receiving a downlink signal from a base station (e.g., the base station 110) or a sidelink signal from another terminal, the terminal 120 may operate as a receiving end.

Referring to FIG. 10, the terminal 120 may include at least one processor 1003, at least one memory 1005, and at least one transceiver 1001. Hereinafter, although each component is described in the singular form, implementations including a plurality of components or subcomponents are not excluded.

The transceiver 1001 performs functions for transmitting and receiving signals through a wireless channel. For example, the transceiver 1001 performs a conversion function between a baseband signal and a bit stream according to a physical layer standard of a system. For example, when transmitting data, the transceiver 1001 generates complex symbols by encoding and modulating a transmission bit stream. In addition, when receiving data, the transceiver 1001 restores a reception bit stream by demodulating and decoding a baseband signal. In addition, the transceiver 1001 up-converts a baseband signal into a radio frequency (RF) band signal and transmits it through an antenna, and down-converts an RF band signal received through an antenna into a baseband signal.

To this end, the transceiver 1001 may include a transmission filter, a reception filter, an amplifier, a mixer, an oscillator, a digital to analog converter (DAC), an analog to digital converter (ADC), and the like. The transceiver 1001 may include a plurality of transmission/reception paths. Furthermore, the transceiver 1001 may include an antenna unit. The transceiver 1001 may include at least one antenna array consisting of a plurality of antenna elements. In terms of hardware, the transceiver 1001 may be configured with a digital circuit and an analog circuit (e.g., a radio frequency integrated circuit (RFIC)). Herein, the digital circuit and the analog circuit may be implemented as one package. In addition, the transceiver 1001 may include a plurality of RF chains. The transceiver 1001 may perform beamforming. The transceiver 1001 may apply a beamforming weight to a signal to be transmitted/received in order to give a directionality according to the setting of the processor 1003. According to an embodiment, the transceiver 1001 may include a radio frequency (RF) block (or RF unit).

The transceiver 1001 transmits and receives a signal as described above. Accordingly, the transceiver 1001 may be referred to as ‘transmission unit’, ‘reception unit’, or ‘transmission/reception unit’. According to an embodiment, the transceiver 1001 may provide an interface for performing communication with other nodes in a network. That is, the transceiver 1001 may convert a bit stream transmitted from the terminal 120 to another node, for example, another access node, another base station, an upper node, a core network into a physical signal, and convert a physical signal received from another node into a bit stream.

The processor 1003 controls overall operations of the terminal 120. For example, the processor 1003 writes and reads data in the memory 1005. For example, the processor 1003 transmits and receives a signal through the transceiver 1001. According to an embodiment, the processor 1003 may obtain a transmission signal from the base station 110 or another terminal, based on a channel estimated using reception reference signals and a whitening matrix applied to reception data. For example, the processor 1003 may perform operations of functional blocks of FIG. 6 or 7. In addition, although FIG. 10 illustrates one processor, embodiments of the disclosure are not limited thereto. The terminal 120 may include at least one processor to perform embodiments of the disclosure. The processor 1003 may be referred to as a control unit or control means. According to embodiments, the processor 1003 may control the terminal 120 to perform at least one of operations or methods according to embodiments of the disclosure.

The memory 1005 may store data such as a basic program, an application program, and setting information for the operation of the terminal 120. The memory 1005 may store various data used by at least one component (e.g., the transceiver 1001 and the processor 1003). For example, the data may include input data or output data for software and instructions associated therewith. The memory 1005 may be composed of a volatile memory, a nonvolatile memory, or a combination of the volatile memory and the nonvolatile memory. In addition, the memory 1005 may provide stored data according to a request from the processor 1003.

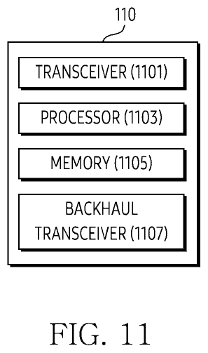

FIG. 11 illustrates a functional configuration of a base station (e.g., the base station 110) according to an embodiment of the disclosure. In receiving an uplink signal of a terminal (e.g., the terminal 120), the base station 110 or RU (e.g., the RU 220) of the base station 110 may operate as a receiving end. Hereinafter, although described based on the base station 110, some descriptions of the base station 110 may also be applied to the RU 220 of the base station 110.

Referring to FIG. 11, the base station 110 may include a transceiver 1101, a processor 1103, memory 1105, and a backhaul transceiver 1107.

The transceiver 1101 may perform functions for transmitting and receiving signals in a wired communication environment. The transceiver 1101 may include a wired interface for controlling a direct connection between devices through a transmission medium (e.g., copper wire, optical fiber). For example, the transceiver 1101 may transmit an electrical signal to another device through a copper wire, or may perform conversion between an electrical signal and an optical signal.

The transceiver 1101 may perform functions for transmitting and receiving signals in a wireless communication environment. For example, the transceiver 1101 may perform a conversion function between a baseband signal and a bit stream, according to a physical layer standard of a system. For example, when transmitting data, the transceiver 1101 generates complex symbols by encoding and modulating a transmission bit stream. In addition, when receiving data, the transceiver 1101 restores a reception bit stream by demodulating and decoding a baseband signal. In addition, the transceiver 1101 may include a plurality of transmission/reception paths.

The transceiver 1101 transmits and receives signals as described above. Accordingly, all or part of the transceiver 1101 may be referred to as ‘communication unit’, ‘transmission unit’, ‘reception unit’, or ‘transmission/reception unit’. In addition, in the following description, transmission and reception performed through a wireless channel are used to mean that processing as described above is performed by the transceiver 1101.

The processor 1103 controls overall operations of the base station 110. The processor 1103 may be referred to as a control unit. For example, the processor 1103 transmits and receives signals through the transceiver 1101 (or the backhaul transceiver 1107). Furthermore, the processor 1103 writes and reads data in the memory 1105. In addition, the processor 1103 may perform functions of a protocol stack required by a communication standard. According to an embodiment, the processor 1103 may obtain a transmission signal at the terminal 120, based on a channel estimated using reception reference signals and a whitening matrix applied to reception data. For example, the processor 1103 may perform operations of the functional blocks of FIG. 6 or 7. Although only the processor 1103 is illustrated in FIG. 11, according to another implementation, the base station 110 may include two or more processors.

In the disclosure, operations of the processor 1103 may be executed by software or may mean controlling hardware components such as a field programmable gate array (FPGA) or an application-specific integrated circuit (ASIC). In addition, the processor 1103 may include components such as software components, object-oriented software components, class components, and task components, and at least one of processes, functions, attributes, procedures, subroutines, segments of program code, drivers, firmware, microcode, circuitry, data, database, data structures, tables, arrays, and variables. The processor 1103 may include at least one module, and the term “module” includes a unit consisting of hardware, software, or firmware. For example, a module may be used interchangeably with terms such as logic, logical blocks, components, or circuits. A module may be a single integral component, or a minimum unit or part thereof, adapted to perform one or more functions. For example, the module may be composed of ASIC.

The memory 1105 stores data such as a basic program, an application program, and setting information for the operation of the base station 110. The memory 1105 may be referred to as a storage unit. The memory 1105 may be composed of a volatile memory, a nonvolatile memory, or a combination of the volatile memory and the nonvolatile memory. In addition, the memory 1105 provides stored data according to a request of the processor 1103.

The base station 110 may further include a backhaul transceiver 1107 to be connected to a core network or other base stations. The backhaul transceiver 1107 provides an interface for performing communication with other nodes in a network. In other words, the backhaul transceiver 1107 converts a bit stream transmitted from a base station to another node, such as another access node, another base station, an upper node, a core network, into a physical signal, and converts a physical signal received from another node into a bit stream.

In the disclosure, by whitening a result of channel estimation for DMRS symbols and performing channel estimation for data symbols based on a result of the whitening, low-complexity whitening implementation may be achieved. In addition, by directly applying a whitening filter to the DMRS symbols and performing channel estimation through the whitened DMRS symbols, not only may complexity be reduced, but also high reception performance (e.g., an improvement of approximately 1.3 dB) may be achieved in interference environments. In the technique of estimating a channel for data symbols (hereinafter, data channel) and then applying a whitening matrix to the estimated data symbols, only interference removal for data symbols was possible. However, in the embodiments of the disclosure, interference removal is possible for DMRS symbols as well, so that channel estimation performance for reception signals may be improved. In addition, since a whitening filter is applied to each RS symbol (e.g., DMRS) instead of applying a whitening filter to each symbol of a data channel, complexity can be reduced.

The receiver according to the embodiments of the disclosure may reduce the influence of interference through the whitening effect and improve the performance of channel estimation. In addition, the receiver according to the embodiments of the disclosure may provide the whitening effect with relatively little complexity by applying the whitening effect to the estimated channel through RS symbols before estimating the channel for reception data.

The effects that can be obtained from the disclosure are not limited to those described above, and any other effects not mentioned herein will be clearly understood by those having ordinary knowledge in the art to which the disclosure belongs, from the following description.

According to embodiments, a method performed by an electronic device in a wireless communication system may comprise obtaining reception data and reception reference signals. The method may comprise obtaining a whitening filter for a noise and interference component based on channel estimation using the reception reference signals. The method may comprise obtaining first whitening channel estimation information for the reception reference signals based on the whitening filter. The method may comprise obtaining second whitening channel estimation information for the reception data based on the first whitening channel estimation information for the reception reference signals. The method may comprise obtaining transmission data corresponding to the reception data based on the second whitening channel estimation information for the reception data.

According to an embodiment, the obtaining the first whitening channel estimation information may comprise applying the whitening filter to a result of channel estimation using the reception reference signals to obtain the first whitening channel estimation information.

According to an embodiment, the obtaining the first whitening channel estimation information may comprise obtaining whitening reference signals by applying the whitening filter to the reception reference signals. The obtaining the first whitening channel estimation information may comprise obtaining the first whitening channel estimation information based on channel estimation using the whitening reference signals.

According to an embodiment, the reception reference signals may include a first reception reference signal (RS) and a second reception RS. The first whitening channel estimation information may include a first RS whitening channel, obtained by applying the whitening filter to the channel of the first reception reference signal, and a second RS whitening channel, obtained by applying the whitening filter to the channel of the second reception reference signal. The second whitening channel estimation information for the reception data may be calculated based on the first RS whitening channel and the second RS whitening channel.

According to an embodiment, the second whitening channel estimation information for the reception data may include a whitening data channel for data symbols. The whitening data channel may be obtained based on a first weight for the data symbols in the first RS whitening channel, a second weight for the data symbols in the second RS whitening channel, the first RS whitening channel, and the second RS whitening channel.

According to an embodiment, a whitening matrix of the whitening filter may be an inverse of a lower-triangular matrix obtained by Cholesky decomposition of an auto-covariance matrix of the noise and interference component.

According to an embodiment, the second whitening channel estimation information for the reception data may be obtained based on information on a frequency offset among reception antennas of the electronic device.

According to an embodiment, the reception reference signals may be received in one or more demodulation reference signal (DMRS) symbols. The reception data may be received in multiple data symbols other than the one or more DMRS symbols within a slot. The second whitening channel estimation information for the reception data may be obtained in a time domain.

According to an embodiment, the obtaining the transmission data may comprise obtaining whitening data by applying the whitening filter to the reception data. The obtaining the transmission data may comprise obtaining the transmission data based on the whitening data and the second whitening channel estimation information.

According to an embodiment, the reception data may be received via a physical uplink shared channel (PUSCH). The reception reference signals may include DMRS symbols for the PUSCH. The electronic device may include a radio unit (RU).

According to embodiments, an electronic device in a wireless communication system may comprise at least one transceiver, and at least one processor. The at least one processor may be configured to obtain reception data and reception reference signals via the at least one transceiver. The at least one processor may be configured to obtain a whitening filter for a noise and interference component based on channel estimation using the reception reference signals. The at least one processor may be configured to obtain first whitening channel estimation information for the reception reference signals based on the whitening filter. The at least one processor may be configured to obtain second whitening channel estimation information for the reception data based on the first whitening channel estimation information for the reception reference signals. The at least one processor may be configured to obtain transmission data corresponding to the reception data based on the second whitening channel estimation information for the reception data.

According to an embodiment, in order to obtain the first whitening channel estimation information, the at least one processor may be configured to obtain first whitening channel estimation information by applying the whitening filter to a result of channel estimation using the reception reference signals.

According to an embodiment, in order to obtain the first whitening channel estimation information, the at least one processor may be configured to obtain whitening reference signals by applying the whitening filter to the reception reference signals. In order to obtain the first whitening channel estimation information, the at least one processor may be configured to obtain the first whitening channel estimation information based on channel estimation using the whitening reference signals.

According to an embodiment, the reception reference signals may include a first reception reference signal (RS) and a second reception RS. The first whitening channel estimation information may include a first RS whitening channel, obtained by applying the whitening filter to the channel of the first reception reference signal, and a second RS whitening channel, obtained by applying the whitening filter to the channel of the second reception reference signal. The second whitening channel estimation information for the reception data may be calculated based on the first RS whitening channel and the second RS whitening channel.

According to an embodiment, the second whitening channel estimation information for the reception data may include a whitening data channel for data symbols. The whitening data channel may be obtained based on a first weight for the data symbols in the first RS whitening channel, a second weight for the data symbols in the second RS whitening channel, the first RS whitening channel, and the second RS whitening channel.

According to an embodiment, a whitening matrix of the whitening filter may be an inverse of a lower-triangular matrix obtained by Cholesky decomposition of an auto-covariance matrix of the noise and interference component.

According to an embodiment, the second whitening channel estimation information for the reception data may be obtained based on information on a frequency offset among reception antennas of the electronic device.

According to an embodiment, the reception reference signals may be received in one or more demodulation reference signal (DMRS) symbols. The reception data may be received in multiple data symbols other than the one or more DMRS symbols within a slot. The second whitening channel estimation information for the reception data may be obtained in a time domain.

According to an embodiment, in order to obtain the transmission data, the at least one processor may be configured to obtain whitening data by applying the whitening filter to the reception data. In order to obtain the transmission data, the at least one processor may be configured to obtain the transmission data based on the whitening data and the second whitening channel estimation information.

According to an embodiment, the reception data may be received via a physical uplink shared channel (PUSCH). The reception reference signals may include DMRS symbols for the PUSCH. The electronic device may include a radio unit (RU).

According to embodiments, one or more non-transitory computer-readable storage media storing instructions that, when executed by at least one processor of an electronic device individually or collectively, cause the electronic device to perform operations, is provided. The operations include obtaining reception data and reception reference signals, obtaining a whitening filter for a noise and interference component based on channel estimation using the reception reference signals, obtaining first whitening channel estimation information for the reception reference signals based on the whitening filter, obtaining second whitening channel estimation information for the reception data based on the first whitening channel estimation information for the reception reference signals, and obtaining transmission data corresponding to the reception data based on the second whitening channel estimation information for the reception data.

Methods according to embodiments described in claims or specifications of the disclosure may be implemented as a form of hardware, software, or a combination of hardware and software.

In a case of implementing as software, a non-transitory computer-readable storage medium for storing one or more programs (software module) may be provided. The one or more programs stored in the non-transitory computer-readable storage medium are configured for execution by one or more processors in an electronic device. The one or more programs include instructions that cause the electronic device to execute the methods according to embodiments described in claims or specifications of the disclosure. The one or more programs may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. In the case of being distributed online, at least part of the computer program product may be temporarily generated or at least temporarily stored in the machine-readable storage medium, such as memory of the manufacturer's server, the application store's server, or a relay server.

Such a program (software module, software) may be stored in a random access memory, a non-volatile memory including a flash memory, a read only memory (ROM), an electrically erasable programmable read only memory (EEPROM), a magnetic disc storage device, a compact disc-ROM (CD-ROM), an optical storage device (digital versatile discs (DVDs) or other formats), or a magnetic cassette. Alternatively, it may be stored in memory configured with a combination of some or all of them. In addition, a plurality of configuration memories may be included.

Additionally, a program may be stored in an attachable storage device that may be accessed through a communication network such as the Internet, Intranet, local area network (LAN), wide area network (WAN), or storage area network (SAN), or a combination thereof. Such a storage device may be connected to a device performing an embodiment of the disclosure through an external port. In addition, a separate storage device on the communication network may also be connected to a device performing an embodiment of the disclosure.

In the above-described specific embodiments of the disclosure, components included in the disclosure are expressed in the singular or plural according to the presented specific embodiment. However, the singular or plural expression is selected appropriately according to a situation presented for convenience of explanation, and the disclosure is not limited to the singular or plural component, and even components expressed in the plural may be configured in the singular, or a component expressed in the singular may be configured in the plural.

According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be executed sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device in a wireless communication system, the method comprising:
obtaining reception data and reception reference signals;
obtaining a whitening filter for a noise and interference component based on channel estimation using the reception reference signals;
obtaining first whitening channel estimation information for the reception reference signals based on the whitening filter;
obtaining second whitening channel estimation information for the reception data based on the first whitening channel estimation information for the reception reference signals; and
obtaining transmission data corresponding to the reception data based on the second whitening channel estimation information for the reception data.

2. The method of claim 1, wherein the obtaining of the first whitening channel estimation information comprises:
applying the whitening filter to a result of channel estimation using the reception reference signals to obtain the first whitening channel estimation information.

3. The method of claim 1, wherein the obtaining of the first whitening channel estimation information comprises:
obtaining whitening reference signals by applying the whitening filter to the reception reference signals; and
obtaining the first whitening channel estimation information based on channel estimation using the whitening reference signals.

4. The method of claim 1,
wherein the reception reference signals include a first reception reference signal (RS) and a second reception RS,
wherein the first whitening channel estimation information includes a first RS whitening channel, obtained by applying the whitening filter to a channel of the first reception reference signal, and a second RS whitening channel, obtained by applying the whitening filter to a channel of the second reception RS, and
wherein the second whitening channel estimation information for the reception data is calculated based on the first RS whitening channel and the second RS whitening channel.

5. The method of claim 4,
wherein the second whitening channel estimation information for the reception data includes a whitening data channel for data symbols, and
wherein the whitening data channel is obtained based on a first weight for the data symbols in the first RS whitening channel, a second weight for the data symbols in the second RS whitening channel, the first RS whitening channel, and the second RS whitening channel.

6. The method of claim 1, wherein a whitening matrix of the whitening filter is an inverse of a lower-triangular matrix obtained by Cholesky decomposition of an auto-covariance matrix of the noise and interference component.

7. The method of claim 1, wherein the second whitening channel estimation information for the reception data is obtained based on information on a frequency offset among reception antennas of the electronic device.

8. The method of claim 1,
wherein the reception reference signals are received in one or more demodulation reference signal (DMRS) symbols,
wherein the reception data is received in multiple data symbols other than the one or more DMRS symbols within a slot, and
wherein the second whitening channel estimation information for the reception data is obtained in a time domain.

9. The method of claim 1, wherein the obtaining of the transmission data comprises:
obtaining whitening data by applying the whitening filter to the reception data; and
obtaining the transmission data based on the whitening data and the second whitening channel estimation information.

10. The method of claim 1,
wherein the reception data is received via a physical uplink shared channel (PUSCH),
wherein the reception reference signals comprises DMRS symbols for the PUSCH, and the electronic device comprises a radio unit (RU).

11. An electronic device in a wireless communication system, the electronic device comprising:
at least one processor; and
memory storing instructions that, when executed by the at least one processor, cause the electronic device to:
obtain reception data and reception reference signals via at least one transceiver,
obtain a whitening filter for a noise and interference component based on channel estimation using the reception reference signals,
obtain first whitening channel estimation information for the reception reference signals based on the whitening filter,
obtain second whitening channel estimation information for the reception data based on the first whitening channel estimation information for the reception reference signals, and
obtain transmission data corresponding to the reception data based on the second whitening channel estimation information for the reception data.

12. The electronic device of claim 11, wherein to obtain the first whitening channel estimation information, the instructions, when executed by the at least one processor, cause the electronic device to:
obtain first whitening channel estimation information by applying the whitening filter to a result of channel estimation using the reception reference signals.

13. The electronic device of claim 11, wherein to obtain the first whitening channel estimation information, the instructions, when executed by the at least one processor, cause the electronic device to:
obtain whitening reference signals by applying the whitening filter to the reception reference signals, and
obtain the first whitening channel estimation information based on channel estimation using the whitening reference signals.

14. The electronic device of claim 11,
wherein the reception reference signals include a first reception reference signal (RS) and a second reception RS,
wherein the first whitening channel estimation information includes a first RS whitening channel, obtained by applying the whitening filter to a channel of the first reception reference signal, and a second RS whitening channel, obtained by applying the whitening filter to a channel of the second reception RS, and
wherein the second whitening channel estimation information for the reception data is calculated based on the first RS whitening channel and the second RS whitening channel.

15. The electronic device of claim 14,
wherein the second whitening channel estimation information for the reception data includes a whitening data channel for data symbols, and
wherein the whitening data channel is obtained based on a first weight for the data symbols in the first RS whitening channel, a second weight for the data symbols in the second RS whitening channel, the first RS whitening channel, and the second RS whitening channel.

16. The electronic device of claim 11, wherein a whitening matrix of the whitening filter is an inverse of a lower-triangular matrix obtained by Cholesky decomposition of an auto-covariance matrix of the noise and interference component.

17. The electronic device of claim 11, wherein the second whitening channel estimation information for the reception data is obtained based on information on a frequency offset among reception antennas of the electronic device.

18. The electronic device of claim 11,
wherein the reception reference signals are received in one or more demodulation reference signal (DMRS) symbols,
wherein the reception data is received in multiple data symbols other than the one or more DMRS symbols within a slot, and
wherein the second whitening channel estimation information for the reception data is obtained in a time domain.

19. The electronic device of claim 11, wherein, to obtain the transmission data, the instructions, when executed by the at least one processor, cause the electronic device to:
obtain whitening data by applying the whitening filter to the reception data, and
obtain the transmission data based on the whitening data and the second whitening channel estimation information,
wherein the reception data is received via a physical uplink shared channel (PUSCH),
wherein the reception reference signals comprises DMRS symbols for the PUSCH and the electronic device comprises a radio unit (RU).

20. One or more non-transitory computer-readable storage media storing instructions that, when executed by at least one processor of an electronic device individually or collectively, cause an electronic device to perform operations, the operations comprising:
obtaining reception data and reception reference signals;
obtaining a whitening filter for a noise and interference component based on channel estimation using the reception reference signals;
obtaining first whitening channel estimation information for the reception reference signals based on the whitening filter;
obtaining second whitening channel estimation information for the reception data based on the first whitening channel estimation information for the reception reference signals; and
obtaining transmission data corresponding to the reception data based on the second whitening channel estimation information for the reception data.
